(19) United States
(12) Patent Application Publication
(10) Pub. No.: US 2023/0163636 A1
(43) Pub. Date: May 25, 2023

(54) Supplying-end module, receiving-end module and communication method thereof

(71) Applicant: Fu Da Tong Technology Co., Ltd., New Taipei City (TW)

(72) Inventors: Ming-Chiu Tsai, New Taipei City (TW); Chi-Che Chan, New Taipei City (TW)

(73) Assignee: Fu Da Tong Technology Co., Ltd., New Taipei City (TW)

(21) Appl. No.: 18/095,527

(22) Filed: Jan. 10, 2023

(30) Foreign Application Priority Data
Sep. 29, 2022 (TW) 111136883

(51) Int. Cl. H02J 50/12; H02J 50/40; H02J 50/80

(52) U.S. Cl. CPC H02J 50/12; H02J 50/80; H02J 50/402

(57) ABSTRACT

A supplying-end module for an induction type power supply system includes a plurality of supplying-end coils and a plurality of power driver circuits. The plurality of supplying-end coils are connected in parallel and include a first terminal and a second terminal. Each of the plurality of power driver circuits includes a first resonant capacitor, a second resonant capacitor, a first driver and a second driver. The first driver is coupled to the first terminal of the plurality of supplying-end coils through the first resonant capacitor, and the second driver is coupled to the second terminal of the plurality of supplying-end coils through the second resonant capacitor.

### BACKGROUND OF THE INVENTION

### 1. Field of the Invention

The present invention relates to a high-power induction type power supply system, and more particularly, to architectures of a supplying-end module and a receiving-end module and their communication method for realizing a high-power induction type power supply system.

### 2. Description of the Prior Art

In an induction type power supply system, the power supplying terminal and the power receiving terminal respectively include a coil for performing inductive power transmissions (or called wireless charging). The coil in the power supplying terminal may deliver energies, and the coil in the power receiving terminal may receive the energies and convert the energies to be provided for the usage of loads. During the power transmission process, the power supplying terminal has to know the operational status of the power receiving terminal, to perform power regulation or other related operations; hence, the power receiving terminal should transmit the data associated with its operational status to the power supplying terminal. However, there is no physical circuitry connected between the power receiving device and the power supplying device, and thus the transmission of data should be performed through a wireless scheme.

In recent years, wireless charging technology has widely been applied in mobile phones. The maximum transmission power of the wireless charging device used by currently available mobile phones is usually lower than 100 watts (W). After mobile phones, the next product that gets people’s attention is electric vehicles. The charging power requirement of an electric vehicle is far greater than the charging power of a mobile phone. In general, in order to achieve a satisfactory user experience, the charging power of an electric vehicle should reach at least 10 kilowatts (kW) ; that is, the charging power demand of an electric vehicle is more than 100 times that of a mobile phone.

The wireless power transmission is performed with cooperation of the power supplying device and the power receiving device. The power supplying device converts the power from an external power supply to electromagnetic energies to be delivered. After sensing the electromagnetic energies, the power receiving device converts the energies into electric power to be output. The energies have to pass through components/devices such as a driver, coil, and rectifier during the conversion process, thereby causing depletions of these components/devices. During the charging of an electric vehicle, the voltage and current are both far greater than those of the charging of a mobile phone, and thus these devices should possess higher power specifications to be able to withstand the large amount of power delivered during operations. The devices with high power specification have the problems of high costs and non-easy production. Thus, there is a need for improvement over the prior art.

### SUMMARY OF THE INVENTION

It is therefore an objective of the present invention to provide a novel structure of an induction type power supply system, where the power supplying terminal may apply multiple coils connected in parallel along with multiple power driver circuits to output synchronously, and the power receiving terminal performs sensing by using multiple coils simultaneously, so as to achieve the effect of power dispersion to solve the abovementioned problems.

An embodiment of the present invention discloses a supplying-end module for an induction type power supply system. The supplying-end module comprises a plurality of supplying-end coils and a plurality of power driver circuits. The plurality of supplying-end coils are connected in parallel and comprise a first terminal and a second terminal. Each of the plurality of power driver circuits comprises a first resonant capacitor, a second resonant capacitor, a first driver and a second driver. The first driver is coupled to the first terminal of the plurality of supplying-end coils through the first resonant capacitor, and the second driver is coupled to the second terminal of the plurality of supplying-end coils through the second resonant capacitor.

Another embodiment of the present invention discloses a receiving-end module for an induction type power supply system. The receiving-end module comprises a plurality of receiving-end coils and a plurality of receiving and rectification circuits. Each of the plurality of receiving and rectification circuits is coupled to a corresponding receiving-end coil among the plurality of receiving-end coils. Wherein, the plurality of receiving and rectification circuits are commonly coupled to a load of the induction type power supply system.

Another embodiment of the present invention discloses a communication method for an induction type power supply system. The induction type power supply system comprises a supplying-end module and a receiving-end module. The communication method comprises steps of: sending, by the supplying-end module, a detection signal to detect the receiving-end module; transmitting, by the receiving-end module, a feedback signal to the supplying-end module by using a coil modulation technique when receiving the detection signal; exchanging, by the supplying-end module and the receiving-end module, a setting data by using the coil modulation technique; and communicating, by a first wireless communication module of the supplying-end module and a second wireless communication module of the receiving-end module, with each other to exchange a power transmission data after the supplying-end module and the receiving-end module complete the exchange of the setting data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a supplying-end module according to an embodiment of the present invention.

FIG. 2 is a schematic diagram of a receiving-end module according to an embodiment of the present invention.

FIG. 3 is a flowchart of a wireless charging process according to an embodiment of the present invention.

### DETAILED DESCRIPTION

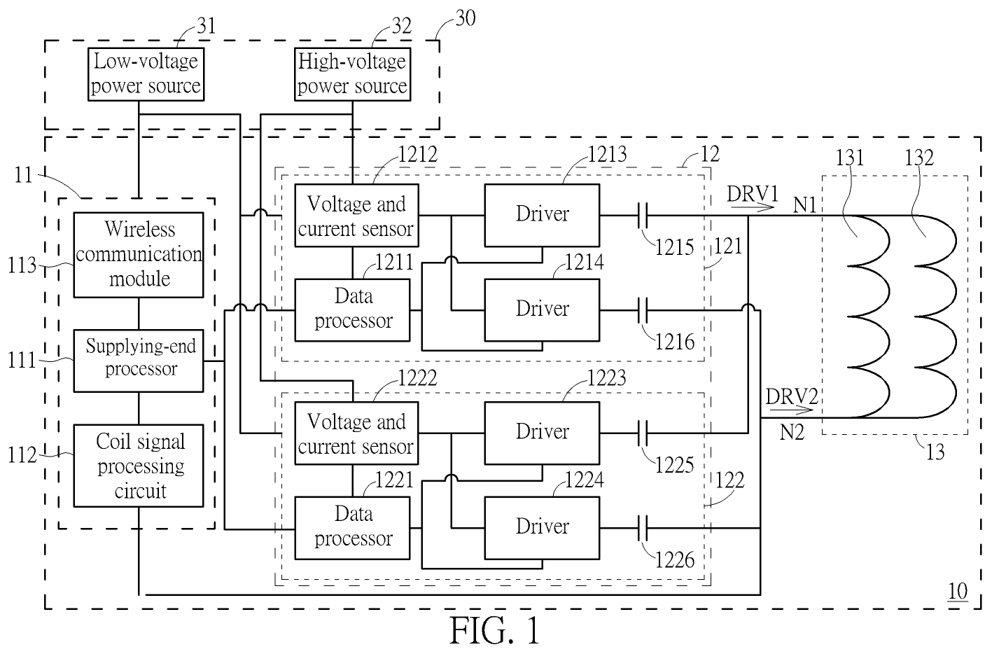

FIG. 1 is a schematic diagram of a supplying-end module 10 according to an embodiment of the present invention. The supplying-end module 10 includes a supplying-end main control circuit 11, a plurality of power driver circuits 12 and a plurality of supplying-end coils 13. The supplying-end module 10 may receive input power from an external power supply 30, and convert the input power into wireless power to be output through the supplying-end coils 13. The power supply 30 may have a low-voltage power source 31 and a high-voltage power source 32, where the low-voltage power source 31 is mainly used for providing a lower voltage for the usage of the supplying-end main control circuit 11, and the high-voltage power source 32 is mainly used for providing a higher voltage for the usage of the power driver circuits 12.

As shown in FIG. 1, the plurality of supplying-end coils 13 are connected in parallel between two terminals N1 and N2. The plurality of supplying-end coils 13 may include any number of supplying-end coils. In the present embodiment, there are two supplying-end coils 131 and 132 as an example for illustrations. Those skilled in the art should understand that, in another embodiment, the number of supplying-end coils may be adjusted according to power demands, and is not limited herein. Similarly, the plurality of power driver circuits 12 may include any number of power driver circuits. In the present embodiment, there are two power driver circuits 121 and 122 as an example for illustrations; but in another embodiment, the number of power driver circuits may be adjusted according to power demands, and is not limited herein. For example, a charging system for the electric vehicle should be able to support a charging current up to 50 A. It is feasible to choose 5 coils having a 10 A current output capability to be connected in parallel along with 5 corresponding power driver circuits for driving.

In detail, the power driver circuit 121 includes drivers 1213 and 1214, resonant capacitors 1215 and 1216, a voltage and current sensor 1212, and a data processor 1211. The power driver circuit 122 includes drivers 1223 and 1224, resonant capacitors 1225 and 1226, a voltage and current sensor 1222, and a data processor 1221. The power driver circuits 121 and 122 have the same structure and operation, and the power driver circuit 121 is taken as an example for illustrations hereinafter. The driver 1213 may be coupled to the terminal N1 of the supplying-end coils 13 through the resonant capacitor 1215, for outputting a driving signal DRV1 to the supplying-end coils 13. The driver 1214 may be coupled to the terminal N2 of the supplying-end coils 13 through the resonant capacitor 1216, for outputting a driving signal DRV2 to the supplying-end coils 13. In general, the driving signals DRV1 and DRV2 are different signals. In an embodiment, the driving signals DRV1 and DRV2 are inverse signals for outputting alternating currents to drive the supplying-end coils 13 to generate energies. The voltage and current sensor 1212 is coupled to the drivers 1213 and 1214, for detecting an input power supply voltage and/or a driving current of the power driver circuit 121, such as the power supply voltage received from the high-voltage power source 32 by the power driver circuit 121 and/or the driving current output to the supplying-end coils 13 by the power driver circuit 121. The data processor 1211, which is coupled to the voltage and current sensor 1212 and the drivers 1213 and 1214, may calculate power information according to the input power supply voltage and/or the driving current, and transmit the power information to the supplying-end main control circuit 11.

Note that the present invention applies multiple supplying-end coils 13 connected in parallel to commonly output power. Since all of the supplying-end coils 13 are commonly coupled between the terminals N1 and N2, they may receive the driving signals DRV1 and DRV2 simultaneously. As a result, the same driving signals DRV1 and DRV2 can make the electromagnetic energies generated by each supplying-end coil 13 to be merged, thereby realizing the high power output, where the energies of the supplying-end coils 13 will not interfere with each other.

Further note that in the power driver circuits 12, each driver should be coupled to the terminal N1 or N2 of the supplying-end coils 13 through a resonant capacitor, i.e., the output terminals of the drivers are coupled through capacitors rather than directly connected. For example, in the structure of the supplying-end module 10 as shown in FIG. 1, the output terminal of the driver 1213 in the power driver circuit 121 is coupled to the output terminal of the driver 1223 in the power driver circuit 122 through the resonant capacitors 1215 and 1225, and the output terminal of the driver 1214 in the power driver circuit 121 is coupled to the output terminal of the driver 1224 in the power driver circuit 122 through the resonant capacitors 1216 and 1226. In general, even if the drivers 1213 and 1223 are both configured to output the driving signal DRV1, the operation timing of their output switches should be identical ideally. However, during the driving process, the turn-on time or turn-off time of the switches may appear to have a slight difference due to structural or environmental mismatch. Since the power driver circuits 12 should drive a great amount of current, the difference of the turn-on time and/or turn-off time may result in that the output current flows inversely to cause the driver to be burnt out if the output terminals of multiple drivers are connected directly without through any capacitor. In order to solve this problem, in the present invention, multiple drivers are commonly coupled to one terminal of the supplying-end coils 13 through resonant capacitors, which means that a driver is coupled to another driver through resonant capacitors, to avoid that the output currents of the drivers flow inversely to cause the burnt-out condition.

In the supplying-end module 10, the data processors 1211 and 1221 are configured to control the operations of the power driver circuits 121 and 122, respectively, while the supplying-end main control circuit 11 is configured to control the overall operations of the supplying-end module 10. In detail, the supplying-end main control circuit 11 includes a supplying-end processor 111, a coil signal processing circuit 112 and a wireless communication module 113. The supplying-end processor 111 is configured to control the power supply operations of the supplying-end module 10, e.g., control the output power of the power driver circuits 12. In an embodiment, the supplying-end processor 111 may be realized with software, to be implemented, for example, in a Central Processing Unit (CPU), Microprocessor, Micro Controller Unit (MCU), or any other type of digital signal processing device or computing device.

The coil signal processing circuit 112 is coupled to the supplying-end coils 13, for detecting the supplying-end coils 13 to receive the modulation signal on the coils. This modulation signal is a signal fed back to the supplying-end coils 13 from a receiving-end module through a coil modulation technique, and may be interpreted and received by the coil signal processing circuit 112. In an embodiment, the coil signal processing circuit 112 may include a hardware circuit for receiving/fetching/amplifying signals from the supplying-end coils 13, and also include a software or hardware circuit for interpreting the coil signals.

In an embodiment, the supplying-end processor 111 may receive the data associated with the modulation signal from the coil signal processing circuit 112 and also receive power information from the data processor 1211 and/or 1221, and control the output power of the power driver circuits 12 accordingly. For example, when the power receiving device determines that the received power is excessively large or excessively small, it may send modulation data to instruct the supplying-end module 10 to adjust the output power. Alternatively, the voltage and current sensor 1212 or 1222 may detect that the voltage output by the high-voltage power source 32 is insufficient, and provide related information for the supplying-end processor 111, so that the supplying-end processor 111 may adjust the output power accordingly.

In addition, the supplying-end processor 111 may further perform error detection on the power driver circuits 12 according to the power information from the data processors 1211 and/or 1221. Under normal conditions, the structures and operations of the power driver circuits 121 and 122 are the same, and thus the power driver circuits 121 and 122 should output substantially identical voltages and currents. This voltage and current information may be detected by the voltage and current sensors 1212 and 1222 and sent to the supplying-end processor 111. If the supplying-end processor 111 finds that the voltage or current output by one of the power driver circuits is not identical to that output by other power driver circuits, the supplying-end processor 111 may determine that this power driver circuit malfunctions, and send a warning signal to inform the user of related information.

In this embodiment, the supplying-end main control circuit 11 may further include the wireless communication module 113, which is used for communicating with the wireless communication module in the receiving-end module, to exchange data during the power transmission process. The wireless communication module 113 is implemented with a control circuit and algorithm capable of realizing the wireless communications, which may be realized by using any appropriate communication technology such as Bluetooth or Wireless Fidelity (Wi-Fi), but not limited thereto.

Please note that the supplying-end module 10 receives power from the low-voltage power source 31 and the high-voltage power source 32 for operations. The low-voltage power source 31 is mainly used for supplying power needed by the supplying-end main control circuit 11. In general, the supplying-end module 10 or the supplying-end main control circuit 11 may further include a regulator, which may convert the power supply voltage received from the low-voltage power source 31 into a voltage suitable for the circuits inside the supplying-end main control circuit 11. For example, the low-voltage power source 31 may output a 12 V power supply voltage to the supplying-end main control circuit 11. The regulator is used to convert the 12 V power supply voltage into 3.3 V to be provided for the usage of each module included in the supplying-end main control circuit 11. On the other hand, the high-voltage power source 32 is used for supplying power needed by the power driver circuits 12. In order to drive the supplying-end coils 13 to output sufficient electromagnetic energies, the power driver circuits 12 have to receive a high enough voltage. For example, in the application of electric vehicle’s charging, the power supply voltage output by the high-voltage power source 32 may be up to 200 V. In addition, in an embodiment, the power for the processing circuits inside the power driver circuits 12 (such as the data processors 1211 and 1221) to perform computation may also be received from the low-voltage power source 31, as shown in FIG. 1.

In the above embodiment, the values of the power supply voltages for the low-voltage power source 31 and the high-voltage power source 32 are merely an operation example used for illustrations. In fact, both the low-voltage power source 31 and the high-voltage power source 32 may output any voltage value. As long as the supplying-end main control circuit 11 and the power driver circuits 12 receive different power supply voltages in different levels, and the power supply voltage output by the high-voltage power source 32 is greater than the power supply voltage output by the low-voltage power source 31, the related implementations should belong to the scope of the present invention.

Since the supplying-end main control circuit 11 and the power driver circuits 12 receive different input voltages, the supplying-end module 10 may apply a modular design, where a low-voltage area and a high-voltage area are disposed in the circuit to realize the supplying-end main control circuit 11 and the power driver circuits 12 respectively and are connected through wires. Preferably, the supplying-end processor 111 in the supplying-end main control circuit 11 should be connected to multiple power driver circuits 12, and thus a bus may be used to perform transmission, so as to send power control commands to multiple power driver circuits 12 and receive related power information from multiple power driver circuits 12. In an embodiment, an Inter-Integrated Circuit (I2C) bus may be applied as a transmission interface to realize the data/signal transmissions between the supplying-end main control circuit 11 and the power driver circuits 12. As a result, the present invention may apply the modular design to reduce the electromagnetic interferences between the high-voltage area and the low-voltage area, with the usage of a bus to reduce the number of conducting wires, so as to reduce system complexity and improve the convenience of maintenance.

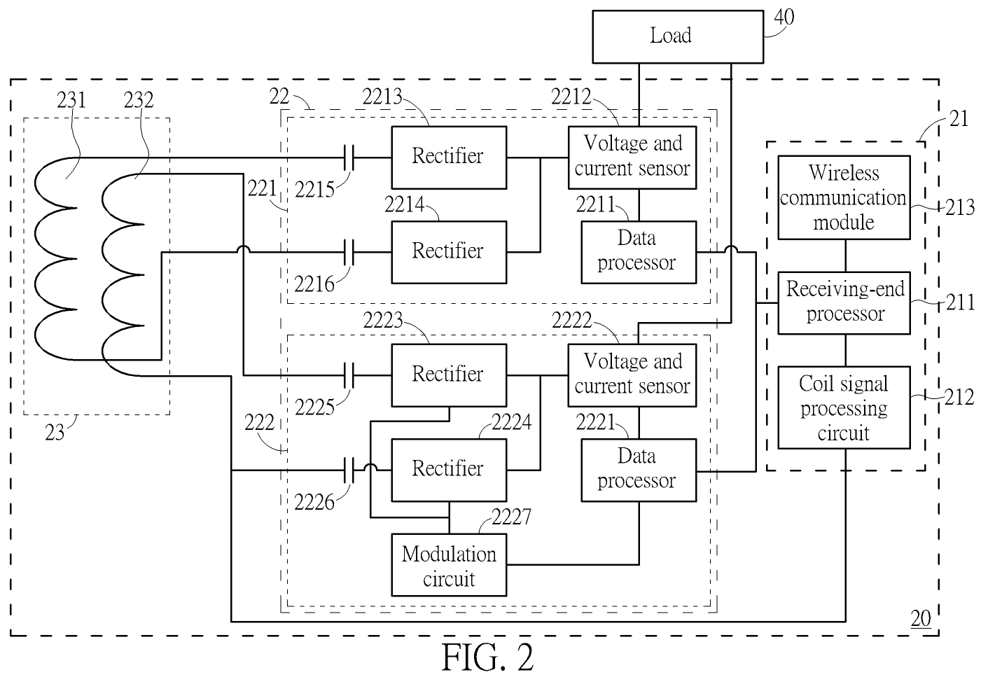

FIG. 2 is a schematic diagram of a receiving-end module 20 according to an embodiment of the present invention. The receiving-end module 20 includes a receiving-end main control circuit 21, a plurality of receiving and rectification circuits 22 and a plurality of receiving-end coils 23. When the receiving-end coils 23 of the receiving-end module 20 receive the inductive electromagnetic energies from the power supplying terminal, the receiving-end coils 23 may convert the energies into DC currents to be output to a load 40. The load 40 may be batteries on an electric vehicle, which is used for receiving power from the receiving-end module 20 to store the power, but not limited thereto.

As shown in FIG. 2, each of the plurality of receiving and rectification circuits 22 is coupled to a corresponding receiving-end coil among the plurality of receiving-end coils 23. The plurality of receiving-end coils 23 may include any number of receiving-end coils. In the present embodiment, there are two receiving-end coils 231 and 232 as an example for illustrations. Those skilled in the art should understand that, in another embodiment, the number of receiving-end coils may be adjusted according to power demands, and is not limited herein. Similarly, the plurality of receiving and rectification circuits 22 may include any number of receiving and rectification circuits. In the present embodiment, there are two receiving and rectification circuits 221 and 222 as an example for illustrations; but in another embodiment, the number of receiving and rectification circuits may be adjusted according to power demands, and is not limited herein. In an embodiment, the number of the receiving and rectification circuits 22 correspond to the number of the receiving-end coils 23. Each of the receiving-end coils 23 is independent and respectively coupled to the corresponding receiving and rectification circuit 22, and each of the receiving and rectification circuits 22 is only coupled to a corresponding receiving-end coil among the receiving-end coils 23, but not coupled to other receiving-end coils. In this embodiment, the receiving-end coil 231 is coupled to the corresponding receiving and rectification circuit 221, and the receiving-end coil 232 is coupled to the corresponding receiving and rectification circuit 222. The back end of each of the receiving and rectification circuits 221 and 222 is commonly coupled to the load 40.

Different from the supplying-end module 10 where the supplying-end coils are commonly coupled between two terminals N1 and N2, in the receiving-end module 20, each of the receiving-end coils 231 and 232 is independent and coupled to the receiving and rectification circuit 221 or 222, respectively. The function of the receiving-end coils 231 and 232 is to capture electromagnetic energies, and there is no signal synchronization problem. Therefore, after each of the receiving-end coils 231 and 232 receives the energies, the energies will be sent to the corresponding receiving and rectification circuit 221 or 222. The receiving and rectification circuits 221 and 222 then perform rectification to generate the output currents to be sent to the load 40.

In detail, the receiving and rectification circuit 221 includes rectifiers 2213 and 2214, resonant capacitors 2215 and 2216, a voltage and current sensor 2212, and a data processor 2211. The receiving and rectification circuit 222 includes rectifiers 2223 and 2224, resonant capacitors 2225 and 2226, a voltage and current sensor 2222, and a data processor 2221. The receiving and rectification circuits 221 and 222 have substantially the same structure and operation, and the receiving and rectification circuit 221 is taken as an example for illustrations hereinafter. The rectifier 2213 may be coupled to the first terminal of the corresponding receiving-end coil 231 through the resonant capacitor 2215, and the rectifier 2214 may be coupled to the second terminal of the corresponding receiving-end coil 231 through the resonant capacitor 2216. The rectifiers 2213 and 2214 may convert the AC current, which is generated by inductive sensing on the receiving-end coil 231, into a DC current to be output. The voltage and current sensor 2212, coupled to the rectifiers 2213 and 2214, is configured to detect an output current and/or output voltage after rectification, e.g., receiving the current/voltage of the rectification circuit 221 to be output to the load 40. The data processor 2211, coupled to the voltage and current sensor 2212, may calculate power output information according to the output current and/or output voltage, and transmit the power output information to the receiving-end main control circuit 21.

As shown in FIG. 2, the receiving and rectification circuit 222 may further include a modulation circuit 2227, which is coupled to the receiving-end coil 232 through the rectifiers 2223 and 2224. The modulation circuit 2227 may generate a modulation signal by using the coil modulation technique and return the modulation signal to the power supplying terminal. Although there are multiple receiving and rectification circuits deployed in the receiving-end module 20, the modulation circuit may need to be deployed in only one of the receiving and rectification circuits. The structures and operations of the modulation circuit should be well known by those skilled in the art, and will not be narrated herein.

In the receiving-end module 20, the data processors 2211 and 2221 are configured to control the operations of the receiving and rectification circuits 221 and 222, respectively, while the receiving-end main control circuit 21 is configured to control the overall operations of the receiving-end module 20. In detail, the receiving-end main control circuit 21 includes a receiving-end processor 211, a coil signal processing circuit 212 and a wireless communication module 213. The receiving-end processor 211 is configured to control the operations of the receiving-end module 20, e.g., control the modulation circuit 2227 to generate and send modulation signals, and/or control the receiving and rectification circuits 22 to output currents to the load 40. In an embodiment, the receiving-end processor 211 may be realized with software, to be implemented, for example, in a CPU, Microprocessor, MCU, or any other type of digital signal processing device or computing device.

The coil signal processing circuit 212 is coupled to the receiving-end coil 232, for detecting the receiving-end coil 232 to receive the signals on the coil. Since each of the receiving-end coils 23 may sense the electromagnetic energies from the power supplying terminal, the coil signal processing circuit 212 only needs to be coupled to one of the receiving-end coils 23. The receiving-end processor 211 may control the operations of the receiving and rectification circuits 221 and 222 according to the coil signals detected by the coil signal processing circuit 212 and/or the power output information received from the data processor 2211 and/or 2221. In an embodiment, the coil signal processing circuit 212 may include a hardware circuit for receiving/capturing/amplifying signals from the receiving-end coil 232, and also include a software or hardware circuit for interpreting the coil signals.

The wireless communication module 213 is used for communicating with the wireless communication module in the supplying-end module, to exchange data during the power transmission process. The wireless communication module 213 is implemented with a control circuit and algorithm capable of realizing the wireless communications, which may be realized by using any appropriate communication technology such as Bluetooth or Wi-Fi, but not limited thereto.

Similarly, the voltage and current sensors 2212 and 2222 in the receiving and rectification circuits 221 and 222 may detect the output voltage/current of the receiving and rectification circuits 221 and 222, respectively, and send the related information to the receiving-end main control circuit 21. The receiving-end processor 211 of the receiving-end main control circuit 21 may determine whether the output voltages/currents of the receiving and rectification circuits 221 and 222 are substantially identical according to the received power output information, to perform error detection on the receiving and rectification circuits 221 and 222. If the receiving-end processor 211 finds that the voltage or current output by one of the receiving and rectification circuits is not identical to that output by other receiving and rectification circuits, the receiving-end processor 211 may determine that this receiving and rectification circuit malfunctions, and send a warning signal to inform the user of related information.

In the receiving-end module 20, each of the receiving and rectification circuits is deployed independently and coupled to the respective receiving-end coil, and its purpose is to facilitate the maintenance and manufacture and to reduce the costs. In the application of electric vehicle charging, the receiving and rectification circuit is requested to process a great amount of current, causing a higher probability of malfunction. Therefore, in the circuit design, each of the receiving and rectification circuits deployed independently may allow the receiving-end processor 211 to easily determine which receiving and rectification circuit malfunctions. Also, when one of the receiving and rectification circuits malfunctions, it is possible to only repair this receiving and rectification circuit without affecting the settings of other receiving and rectification circuits.

In order to realize accurate wireless charging operations, the supplying-end module 10 and the receiving-end module 20 should communicate appropriately. In an embodiment, the in-band communication with coil modulation and the out-band communication using the wireless communication modules may be cooperated to realize a satisfactory communication performance.

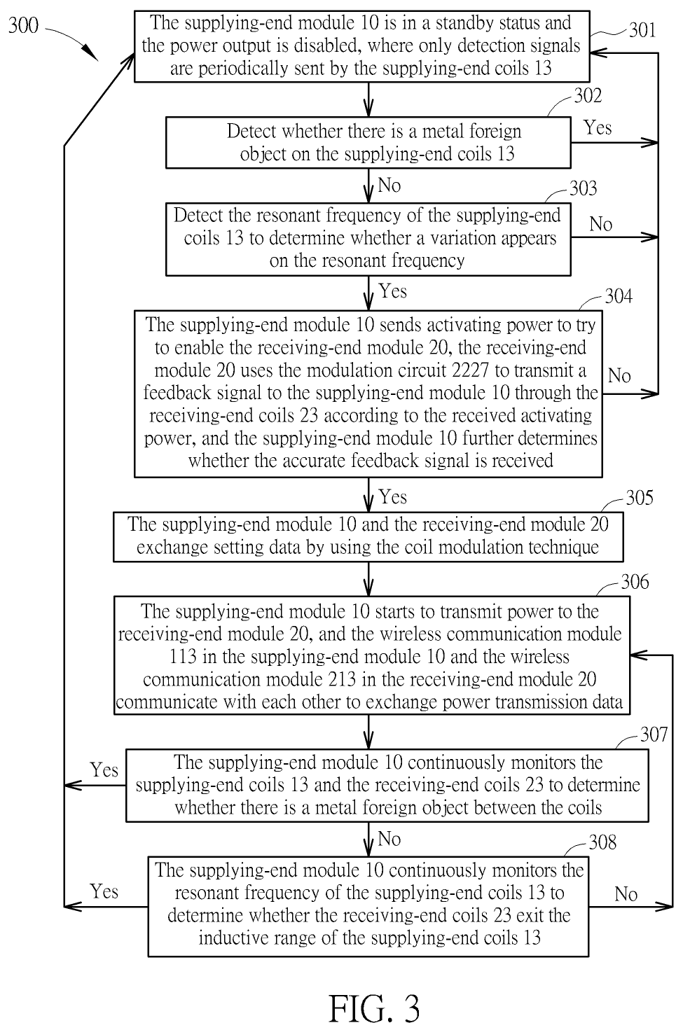

FIG. 3 is a flowchart of a wireless charging process 300 according to an embodiment of the present invention. The wireless charging process 300 may be used for the supplying-end module and the receiving-end module of an induction type power supply system, such as the supplying-end module 10 shown in FIG. 1 and the receiving-end module 20 shown in FIG. 2. As shown in FIG. 3, the wireless charging process 300 includes the following steps:

Step 301: The supplying-end module 10 is in a standby status and the power output is disabled, where only detection signals are periodically sent by the supplying-end coils 13.

Step 302: Detect whether there is a metal foreign object on the supplying-end coils 13. If yes, return to Step 301; otherwise, proceed to Step 303.

Step 303: Detect the resonant frequency of the supplying-end coils 13 to determine whether a variation appears on the resonant frequency. If yes, proceed to Step 304; otherwise, return to Step 301.

Step 304: The supplying-end module 10 sends activating power to try to enable the receiving-end module 20, the receiving-end module 20 uses the modulation circuit 2227 to transmit a feedback signal to the supplying-end module 10 through the receiving-end coils 23 according to the received activating power, and the supplying-end module 10 further determines whether the accurate feedback signal is received. If yes, proceed to Step 305; otherwise, return to Step 301.

Step 305: The supplying-end module 10 and the receiving-end module 20 exchange setting data by using the coil modulation technique.

Step 306: The supplying-end module 10 starts to transmit power to the receiving-end module 20, and the wireless communication module 113 in the supplying-end module 10 and the wireless communication module 213 in the receiving-end module 20 communicate with each other to exchange power transmission data.

Step 307: The supplying-end module 10 continuously monitors the supplying-end coils 13 and the receiving-end coils 23 to determine whether there is a metal foreign object between the coils. If yes, return to Step 301; otherwise, proceed to Step 308.

Step 308: The supplying-end module 10 continuously monitors the resonant frequency of the supplying-end coils 13 to determine whether the receiving-end coils 23 exit the inductive range of the supplying-end coils 13. If yes, return to Step 301; otherwise, go to Step 306.

According to the wireless charging process 300, the supplying-end module 10 (e.g., a charging device deployed in a charging station for electric vehicles) first enters a standby status and disables the power output after powered on. At this moment, the supplying-end coils 13 only periodically send detection signals (Step 301). Disabling the power output in the standby status may reduce power consumption and ensure safety. Since electromagnetic energies may heat a metal object, enabling the power output impetuously when the existence of unknown metal objects is not yet confirmed will easily cause dangers; hence, it is necessary to ensure that the receiving-end module 20 is certainly near the supplying-end coils 13 and that there is no metal object, and then the power transmission can be turned on. Under the standby status, in order to confirm whether the receiving-end module 20 enters the inductive range of the supplying-end coils 13, the supplying-end module 10 may periodically send detection signals. The energies of the detection signals should be quite low, to prevent a metal foreign object from being heated to generate damages.

Under the standby status, the supplying-end module 10 may also periodically detect whether there is a metal foreign object on or near the supplying-end coils 13 (Step 302). In an embodiment, any one or more drivers of the power driver circuits 12 may be utilized to shortly output driving signals, allowing the resonant capacitors and the supplying-end coils 13 to appear resonance, and then stop driving. During the short driving period, the coil signal processing circuit 112 may analyze the signals on the coils, and monitor the attenuation behavior of the resonant signals on the coils, in order to determine whether there is a metal foreign object. For example, if the attenuation speed of the resonant signals is too fast, there may be a metal foreign object which is absorbing the resonant energies. In such a situation, the supplying-end module 10 will stay in the standby status and not enable the power output.

As mentioned above, the supplying-end module 10 may periodically send detection signals to determine whether the receiving-end module 20 enters the inductive range of the supplying-end coils 13. In general, the supplying-end coils 13 and the receiving-end coils 23 are both deployed with a shielding material (e.g., a magnetic conductor), which influences the inductance value on the coils and also influences the resonant frequency of the coils. When the receiving-end coils 23 approach the supplying-end coils 13, the shielding material may influence the nearby coils to change their inductance values. Under the fixed resonant capacitance, the generated resonant frequency will change following the inductance value. By using the detection signals to shortly drive to make the supplying-end coils 13 enter a resonating status, the coil signal processing circuit 112 may be applied to detect whether the resonant frequency of the supplying-end coils 13 has a variation (Step 303), in order to determine whether there is/are another coil(s) (e.g., the receiving-end coils 23) approaching. If no other coil is detected, the supplying-end module 10 may keep at the standby status, and continuously perform metal object detection and resonant frequency detection periodically.

If detecting another coil(s) is/are approaching, the supplying-end module 10 may further confirm whether the approaching coil(s) belongs to a receiving-end device which is ready to receive power (e.g., the power receiving equipment on an electric vehicle) such as the receiving-end module 20. Since the receiving-end module 20 has no operating power at this moment, the power driver circuits 12 should operate by a small time (e.g., 1 second) to send activating power to the receiving-end module 20, allowing the receiving-end module 20 to receive enough electromagnetic energies to be activated. After being activated, the receiving-end module 20 may first use the modulation circuit 2227 to generate and feedback a signal (e.g., an activation code for authentication) to the supplying-end coils 13. The supplying-end module 10 then analyzes the feedback signal through the coil signal processing circuit 112 (Step 304), and extends the power transmission time after confirming that the received activation code is accurate, so as to perform the following steps. If the supplying-end module 10 does not obtain the accurate activation code or not receive any feedback signal, it may return to the standby status.

After the supplying-end module 10 confirms the existence of the receiving-end module 20, the supplying-end module 10 may exchange setting data with the receiving-end module 20 by using the coil modulation technique (Step 305) . This setting data includes charging setting and communication setting, but not limited thereto. In an embodiment, the supplying-end module 10 and the receiving-end module 20 may exchange the setting data to acknowledge the negotiation between the wireless communication module 113 of the supplying-end module 10 and the wireless communication module 213 of the receiving-end module 20.

Subsequently, after the supplying-end module 10 and the receiving-end module 20 complete the charging setting, the supplying-end module 10 may start to deliver normal power to the receiving-end module 20. In addition, the exchange of charging setting has been completed in the previous step, and thus the wireless communication modules 113 and 213 may start to communicate and exchange power transmission data (Step 306) . The power transmission data may be any data needed during the charging process. In an embodiment, the receiving-end module 20 may change its charging mode and request more charging energies, or may notify the supplying-end module 10 to reduce charging energies since its battery is fully charged. In another embodiment, the receiving-end module 20 may be moving such that the distance between the receiving-end coils 23 and the supplying-end coils 13 changes; hence, the receiving-end module 20 may notify the supplying-end module 10 to adjust the transmitted power level. The above information may be transmitted through the wireless communication modules 113 and 213 during the charging process.

Please note that in a low-power wireless charging system (e.g., the wireless charging of mobile phones), the coil modulation technique may be utilized to perform communications during the charging process, and the analysis circuit of the power supplying terminal may be applied to effectively obtain the modulation signals. However, in the charging process of an electric vehicle, the coils have to transmit high power up to tens of thousands of watts (W). In general, when the power level exceeds 1000 W, it is very hard to use the coils to perform communications. This is because the noises generated by power transmission are far greater than the modulation signals. In such a situation, during the period where the supplying-end module 10 transmits power to the receiving-end module 20, it is necessary to use the wireless communication modules 113 and 213 to communicate with each other to deliver data.

Wireless communication technologies such as Bluetooth and Wi-Fi are common communication methods. These wireless communication technologies have a wide communication range; hence, a Bluetooth module or a Wi-Fi module may simultaneously detect or connect to multiple communication modules using the same communication protocol. However, under the present technology, it may not know which connected communication module is the corresponding one in the power supplying device or the power receiving device. For example, when an electric vehicle enters the charging station, its Bluetooth module of the power receiver may detect the Bluetooth modules on multiple charging devices (e.g., on different parking spaces), but might not know which Bluetooth module to pair with to perform charging accurately. Conventionally, the user is requested to manually input a number to pair the wireless communication modules, which causes inconvenience in usage.

Therefore, according to the present invention, the supplying-end module 10 may exchange setting data with the receiving-end module 20 through the coil modulation technique before starting to transmit power to the receiving-end module 20, so that the supplying-end module 10 and the receiving-end module 20 may confirm that they are accurate counterparts for communication, so as to establish the authentication of the wireless communication modules. After the authentication is completed, the supplying-end module 10 and the receiving-end module 20 may use the wireless communication modules 113 and 213 to perform communications, to send subsequent data such as power transmission data. The supplying-end module 10 may further adjust power output according to the power transmission data.

During the charging process, the supplying-end module 10 should continuously monitor the supplying-end coils 13 and the receiving-end coils 23 to determine whether there is a metal foreign object between the coils (Step 307). Simultaneously, the supplying-end module 10 may continuously monitor the resonant frequency of the supplying-end coils 13, to determine whether the receiving-end coils 23 leave the inductive range of the supplying-end coils 13 (Step 308) . If any of the above conditions occurs, the supplying-end module 10 will stop the power output and return to the standby mode/status.

To sum up, the present invention provides a high-power induction type power supply system, of which the power supplying terminal may apply multiple coils connected in parallel along with multiple power driver circuits to output synchronously, and the power receiving terminal performs inductive sensing through multiple coils simultaneously, so as to achieve the effect of power dispersion. In general, the coils, driver devices and rectification devices with high-power specification usually have high costs and are not easily manufactured. Therefore, the present invention may use multiple devices with a lower power specification combined in parallel to realize the high-power transmission. By this method, both the supplying-end module and the receiving-end module have the advantages of easy manufacture and maintenance and lower costs, and the modular design also facilitates the convenience of product manufacture. In addition, in the conventional induction type power supply system where a wireless communication module is applied to perform out-band communications, the wireless communication module always cannot recognize the accurate communication object, and the communications through coil modulation are hard to be realized under high-power transmission. In contrast, according to the embodiments of the present invention, the coil modulation technique may be applied to exchange setting data before the start of power transmission. After the setting is completed, the wireless communication module starts to be used to perform communications. This improves the communication performance of the induction type power supply system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A supplying-end module for an induction type power supply system comprising:
a plurality of supplying-end coils, connected in parallel and comprising a first terminal and a second terminal;
a plurality of power driver circuits, each comprising:
a first resonant capacitor;
a second resonant capacitor;
a first driver, coupled to the first terminal of the plurality of supplying-end coils through the first resonant capacitor; and
a second driver, coupled to the second terminal of the plurality of supplying-end coils through the second resonant capacitor.

2. The supplying-end module of claim 1, wherein the first driver is configured to output a first driving signal to the plurality of supplying-end coils, and the second driver is configured to output a second driving signal different from the first driving signal to the plurality of supplying-end coils.

3. The supplying-end module of claim 1, wherein each of the plurality of power driver circuits further comprises:
a voltage and current sensor, coupled to the first driver and the second driver, configured to detect an input power supply voltage and a driving current; and
a data processor, coupled to the voltage and current sensor, the first driver and the second driver, configured to calculate power information according to the input power supply voltage and the driving current, and transmit the power information to a supplying-end main control circuit.

4. The supplying-end module of claim 1, further comprising:
a supplying-end main control circuit, comprising:
a coil signal processing circuit, coupled to the plurality of supplying-end coils, configured to detect a modulation signal on the plurality of supplying-end coils; and
a supplying-end processor, coupled to the coil signal processing circuit, configured to receive the modulation signal, and control an output power of the plurality of power driver circuits according to the modulation signal and a plurality of power information received from the plurality of power driver circuits.

5. The supplying-end module of claim 4, wherein the supplying-end main control circuit further performs an error detection on the plurality of power driver circuits according to the plurality of power information.

6. The supplying-end module of claim 4, wherein the supplying-end main control circuit further comprises:
a wireless communication module, coupled to the supplying-end processor, configured to communicate with another wireless communication module in a receiving-end module of the induction type power supply system.

7. The supplying-end module of claim 4, wherein the supplying-end main control circuit receives a first power supply voltage for operations, and the plurality of power driver circuits receive a second power supply voltage for operations, wherein the second power supply voltage is greater than the first power supply voltage.

8. The supplying-end module of claim 1, wherein the first driver in a first power driver circuit among the plurality of power driver circuits is coupled to the first driver in a second power driver circuit among the plurality of power driver circuits through the first resonant capacitor, and the second driver in the first power driver circuit is coupled to the second driver in the second power driver circuit through the second resonant capacitor.

9. A receiving-end module for an induction type power supply system comprising:
a plurality of receiving-end coils; and
a plurality of receiving and rectification circuits, each coupled to a corresponding receiving-end coil among the plurality of receiving-end coils;
wherein the plurality of receiving and rectification circuits are commonly coupled to a load of the induction type power supply system.

10. The receiving-end module of claim 9, wherein each of the plurality of receiving and rectification circuits comprises:
a first rectifier, coupled to a first terminal of the corresponding receiving-end coil among the plurality of receiving-end coils through a first resonant capacitor; and
a second rectifier, coupled to a second terminal of the corresponding receiving-end coil among the plurality of receiving-end coils through a second resonant capacitor.

11. The receiving-end module of claim 10, wherein each of the plurality of receiving and rectification circuits further comprises:
a voltage and current sensor, coupled to the first rectifier and the second rectifier, configured to detect an output current and an output voltage after being rectified; and
a data processor, coupled to the voltage and current sensor, configured to calculate power output information according to the output current and the output voltage, and transmit the power output information to a receiving-end main control circuit.

12. The receiving-end module of claim 9, wherein the plurality of receiving-end coils are independent to each other and each of the plurality of receiving-end coils is coupled to the corresponding receiving and rectification circuit.

13. The receiving-end module of claim 9, wherein each of the plurality of receiving and rectification circuits is only coupled to a corresponding receiving-end coil among the plurality of receiving-end coils without being coupled to other receiving-end coils.

14. The receiving-end module of claim 9, further comprising:
a receiving-end main control circuit, comprising:
a coil signal processing circuit, coupled to one of the plurality of receiving-end coils, configured to detect a coil signal on the one of the plurality of receiving-end coils; and
a receiving-end processor, coupled to the coil signal processing circuit, configured to receive the coil signal, and control an operation of the plurality of receiving and rectification circuits according to the coil signal and a plurality of power output information received from the plurality of receiving and rectification circuits.

15. The receiving-end module of claim 14, wherein the receiving-end main control circuit further performs an error detection on the plurality of receiving and rectification circuits according to the plurality of power output information.

16. The receiving-end module of claim 14, wherein the receiving-end main control circuit further comprises:
a wireless communication module, coupled to the receiving-end processor, configured to communicate with another wireless communication module in a supplying-end module of the induction type power supply system.

17. A communication method for an induction type power supply system,
the induction type power supply system comprising a supplying-end module and a receiving-end module, the communication method comprising:
sending, by the supplying-end module, a detection signal to detect the receiving-end module;
transmitting, by the receiving-end module, a feedback signal to the supplying-end module by using a coil modulation technique when receiving the detection signal;
exchanging, by the supplying-end module and the receiving-end module, a setting data by using the coil modulation technique; and
communicating, by a first wireless communication module of the supplying-end module and a second wireless communication module of the receiving-end module, with each other to exchange a power transmission data after the supplying-end module and the receiving-end module complete the exchange of the setting data.

18. The communication method of claim 17, wherein the step of the first wireless communication module and the second wireless communication module communicating with each other is performed during a period where the supplying-end module transmits power to the receiving-end module.

19. The communication method of claim 17, wherein the step of the supplying-end module and the receiving-end module exchanging the setting data by using the coil modulation technique is performed before the supplying-end module starts to transmit power to the receiving-end module.

20. The communication method of claim 17, wherein the power transmission data are used for notifying the supplying-end module to adjust an output power.
